(19) United States
(12) Patent Application Publication
(10) Pub. No.: US 2015/0026406 A1
(43) Pub. Date: Jan. 22, 2015

(54) SIZE ADJUSTING CACHES BY WAY

(71) Applicant: Advanced Micro Devices, Inc., Sunnyvale, CA (US)

(72) Inventors: Edward J. McLellan, Holliston, MA (US); Sudha Thiruvengadam, Austin, TX (US); Douglas R. Beard, Austin, TX (US); Carl D. Dietz, Columbia City, IN (US); Stephen V. Kosonocky, Fort Collins, CO (US)

(73) Assignee: Advanced Micro Devices, Inc., Sunnyvale, CA (US)

(21) Appl. No.: 13/946,120

(22) Filed: Jul. 19, 2013

(51) Int. Cl. G06F 12/08

(52) U.S. Cl. CPC G06F 12/0864
USPC 711/128

(57) ABSTRACT

A size of a cache of a processing system is adjusted by ways, such that each set of the cache has the same number of ways. The cache is a set-associative cache, whereby each set includes a number of ways. In response to defined events at the processing system, a cache controller changes the number of ways of each set of the cache. For example, in response to a processor core indicating that it is entering a period of reduced activity, the cache controller can reduce the number of ways available in each set of the cache.

### CROSS-REFERENCE TO RELATED APPLICATIONS

The present application is related to co-pending U.S. patent application Ser. No.______ (Attorney Docket No. 1458-120309), entitled “SIZE ADJUSTING CACHES BASED ON PROCESSOR POWER MODE” and filed on even date herewith, the entirety of which is incorporated by reference herein.

### FIELD OF THE DISCLOSURE

The present disclosure relates generally to processors and more particularly to processor caches.

### BACKGROUND

A multicore processor typically employs a memory hierarchy having multiple caches to store data for the processor cores. In some configurations, the memory hierarchy includes a dedicated cache for each processor core, one or more shared caches, and system memory. Each processor core stores data accessed recently or predicted to be accessed soon at its dedicated cache, stores data accessed less recently or predicted to be accessed somewhat later at the one or more shared caches, and stores data that is not predicted to be accessed (or predicted to be accessed much later) at the system memory. To enhance processor efficiency, the one or more shared caches are typically designed to have a relatively large capacity as compared to the dedicated caches. In addition, to reduce access latency to the memory hierarchy, the one or more shared caches are typically operated with a relatively high voltage as compared to the system memory. The one or more shared caches can therefore contribute significantly to the power consumption of the processor.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a processing system having a cache whose size can be adjusted by ways in accordance with some embodiments.

FIG. 2 is a diagram illustrating changing a size of the L2 cache of the processing system of FIG. 1 in accordance with some embodiments.

FIG. 3 is a timeline illustrating adjusting the size of the shared cache of FIG. 1 by ways in accordance with some embodiments.

FIG. 4 is a flow diagram of a method of adjusting a size of a cache by ways in accordance with some embodiments.

FIG. 5 is a flow diagram illustrating a method for designing and fabricating an integrated circuit device implementing at least a portion of a component of a processing system in accordance with some embodiments.

The use of the same reference symbols in different drawings indicates similar or identical items.

### DETAILED DESCRIPTION

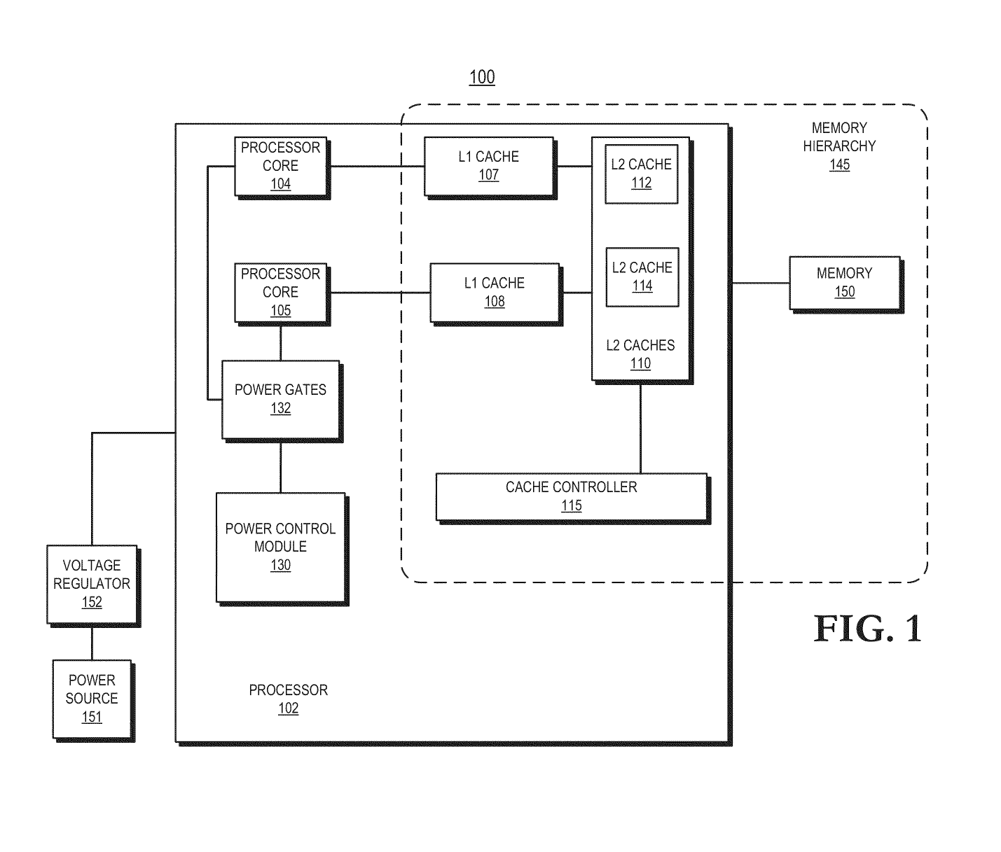

FIGS. 1-5 illustrate example techniques for reducing power consumption at a cache of a processing system through adjusting the size of the cache by ways. The cache is a set-associative cache, whereby each set includes a number of ways. In response to defined events at the processing system, a cache controller changes the number of ways of each set of the cache. For example, in response to a processor core indicating that it is entering a period of reduced activity, the cache controller can reduce the number of ways available in each set of the cache, thereby reducing power consumption by the cache.

Further, because the cache controller changes the ways of all sets in the cache commensurately, power consumption at the cache is reduced while still allowing for good performance at the processor. In contrast, the cache controller could reduce power consumption at the cache by removing the availability of entire sets individually, but such a technique could impact performance by requiring the processor to frequently reorganize the cache. In another scenario, the cache controller could remove the availability of ways of different sets independently, but such a technique may not substantially reduce the number of ways in use at the cache, and therefore may not substantially reduce cache power consumption.

FIG. 1 illustrates a processing system 100 having a cache with an adjustable size in accordance with some embodiments. The processing system 100 can be used in any of a variety of electronic devices, such as a personal computer, server, portable electronic device such as a cellular phone or smartphone, a game system, set-top box, and the like. The processing system 100 generally stores and executes instructions organized as computer programs in order to carry out tasks defined by the computer programs, such as data processing, communication with other electronic devices via a network, multimedia playback and recording, execution of computer applications, and the like.

The processing system 100 includes a processor 102, a memory 150, a power source 151, and a voltage regulator 152. The power source 151 can be any source that can provide electrical power, such as a battery, fuel cell, alternating current source (e.g. an electrical outlet or electrical generator), and the like. In some embodiments the power source 151 also includes modules to regulate the form of the provided electrical power, such as modules to convert an alternating current to direct current. In either scenario, the power source 151 provides the electrical power via an output voltage. The voltage regulator 152 regulates the output voltage to provide a power supply voltage that it maintains with specified limits. The power supply voltage provides power to the processor 102, and can also provide power to other components of the processing system 100, such as the memory 150.

The memory 150 includes one or more storage devices that manipulate electrical energy in order to store and retrieve data. Accordingly, the memory 150 can be random access memory (RAM), hard disk drives, flash memory, and the like, or any combination thereof. The memory 150 is generally configured both to store the instructions to be executed by the processor 102 in the form of computer programs and to store the data that is manipulated by the executing instructions.

To facilitate the execution of instructions, the processor 102 includes multiple processor cores (e.g. processor cores 104 and 105). Each processor core includes one or more instruction pipelines to fetch, decode, dispatch, execute, and retire instructions. An operating system (OS) executing at the processor 102 assigns the particular instructions to be executed to each processor core. To illustrate, a particular sequence of instructions to be executed by a processor core is referred to as a program thread. A thread can represent either an entire a computer program or a portion thereof assigned to carry out a particular task. For a computer program to be executed, the OS identifies the program threads of the computer program and assigns (schedules) the threads for execution at the processor cores 104 and 105. To enhance processing efficiency, the processor cores 104 and 105 are configured to execute their assigned program threads (either from the same computer program or different computer programs) in parallel.

In some operating scenarios, there will be more threads to be executed than there are processor cores to execute them. In these scenarios, the OS selects and schedules the threads to be executed based on a defined prioritization scheme. The changing of the particular thread assigned to a given processor core is referred to as a context switch. The OS enhances processing efficiency by performing context switches in response to defined system conditions, such as a given executing thread awaiting data from the memory 150.

In some operating scenarios, there will be fewer program threads scheduled for execution at the processing system 100 than there are processor cores needed to execute the program threads. Accordingly, to conserve power, the processing system 100 includes a power control module 130 and power gates 132 that cooperate to control the power supplied individually to the processor cores 104 and 105. In some embodiments, the power gates 132 are implemented by a set of switches that are controlled by the power control module 130 to selectively couple and decouple the voltage supplied by the voltage regulator 152 to the processor cores 104 and 105. In response to receiving an indication from the OS that a processor core is not scheduled to execute a program thread, the power control module 130 sets the state of the power gates 132 so that power is not supplied (or a reduced amount of power is supplied) to that processor core. This selective power reduction is referred to as “power gating” the processor core. While a processor core is power gated, it may retain some state information, but cannot execute a program thread. In response to receiving an indication from the OS that a program thread has been scheduled for execution at a processor core that is power gated, the power control module 130 sets the state of the power gates 132 so that power is again supplied (or an increased amount of power is supplied) to that processor core. The processor core is thereby placed in an operational state wherein it can execute the instructions of one or more program threads.

In the course of executing instructions, each of the processor cores 104 and 105 stores and retrieves data from a memory hierarchy 145 that includes the memory 150 and a set of caches including level 1 (L1) caches 107 and 108 and level 2 (L2 caches) 110, including L2 cache 112 and L2 cache 114. The level of a cache indicates its position in the memory hierarchy 145, with the L1 caches 107 and 108 representing the highest level, the L2 caches 110 the next-lower level, and the memory 150 representing the lowest level. In the illustrated example, each of the L1 caches 107 and 108 is dedicated to a corresponding processor core (processor cores 104 and 105 respectively), such that each L1 cache only responds to load and store operations from the processor core to which it is dedicated. In contrast, the L2 caches 110 are shared between the processor cores 104 and 105, such that the L2 caches 110 can store and retrieve data on behalf of either processor core. In some embodiments, the L2 caches are assigned to particular executing threads, such that an L2 cache only stores data for the threads to which it is assigned.

The memory hierarchy 145 is configured to store data in a hierarchical fashion, such that the lowest level (the memory 150) stores all system data, and other levels store a subset of the system data. The processor cores 104 and 105 access (read or write) data in the memory hierarchy 145 via memory access operations, whereby each memory access operation indicates a memory address of the data to be accessed. In the event that a particular level of the memory hierarchy does not store data associated with the memory address of a received memory access, it requests the data from the next-lower level of the memory hierarchy. In this fashion, data traverses the memory hierarchy, such that the L1 caches 107 and 108 store the data most recently requested by the processor cores 104 and 105 respectively.

As used herein, the size of a cache refers to the number of entries of the cache that can be employed to respond to memory access operations. The L1 caches 107 and 108 and the L2 caches 110 are limited in size such that, in some scenarios, they cannot store all the data that is the subject of memory access operations from the processor cores 104 and 105. Accordingly, the memory hierarchy 145 includes a cache controller 115 to manage the data stored at each cache. To illustrate, in some embodiments the L1 caches 107 and 108 and the L2 caches 110 are configured as set-associative caches whereby each cache includes a defined number of sets with each set including a defined number of entries, referred to as ways. The cache controller 115 assigns each set of a cache to a particular range of memory addresses using a subset of the memory address, referred to as an index, such that each way of a set can only store data for memory addresses in its range. The number of sets in the cache is determined by the number of bits in the index. Within each set, the data for any memory address having a matching index may be stored in any of the ways. The memory locations stored in the ways are identified by a different subset of the memory address bits, referred to as the tag. Although the cache controller 115 is illustrated as being shared by the caches 107, 108, 110, it is contemplated that in some embodiments, its functionality may be distributed such that each cache 107, 108, 110 has its own control logic.

In response to receiving a memory access operation for a particular cache, the cache controller 115 determines which set includes the memory address of the memory access operation in its assigned range. The cache controller 115 then determines whether one of the ways of the set stores data associated with the memory address and, if so, satisfies the memory access operation. The cache controller 115 uses the index bits to identify the set, and then concurrently checks all of the ways of the set to determine if any of the ways include entries corresponding to the tag. If none of the ways of the set stores data associated with the memory address, the cache controller 115 determines whether there is an available and empty way to store the data associated with the memory address. A way is empty to store the data if it does not store valid data associated with another memory address in the set's memory address range. As used herein, a way is not available if the way is not represented by a tag array or other data structure that allows the way to be accessed. Similarly, as used herein, a way is available if it is represented by the tag array or other data structure without reconfiguration of the structure. A way that has been transitioned from being available to being unavailable is referred to as having been removed from the cache.

If there is an empty way, the cache controller 115 assigns the empty way to the memory address and satisfies the memory access operation, either (in the case of a store operation) by storing data associated with the memory access operation or (in the case of a load operation) by retrieving data associated with the memory address from lower levels in the memory hierarchy 145, storing it at the selected way, and providing the retrieved data to the requester.

If the cache controller 115 determines there is not an empty way for a given memory access operation, it selects one of the ways of the set for replacement based on a defined replacement algorithm, such as a least-recently-used (LRU) algorithm, most-recently used (MRU) algorithm, random replacement algorithm, and the like. The cache controller 115 evicts the selected way by transferring the data stored at the selected way to the next-higher level of the memory hierarchy 145, and then satisfies the memory access operation at the selected way.

For the L2 caches 110, the cache controller 115 can adjust the size of the caches based on defined conditions as described further herein. In particular, each of the L2 caches 110 is configured as a set-associative cache, with a given number of ways in each set. The cache controller 115 adjusts the size of a given L2 cache by changing the number of ways assigned to each set of the cache. To illustrate, L2 cache 112 can have a sufficient number of bit cells to implement an M-way set-associative cache. However, the cache controller 115 can limit the number of ways assigned to each set to N ways, where N is less than M, as described further below. Because the use of each way in a set consumes power, limiting the size of an L2 cache can reduce power consumption at the processor 102, at the cost of a potentially higher cache eviction rate and reduced processing efficiency. To ensure that the size limit placed on an L2 cache does not unduly impact processing efficiency, the cache controller 115 can adjust the sizes of the L2 caches 110 over time based on defined criteria, such as processing efficiency, the power state of one or more processor cores, switching of threads at a processor core, and the like.

To illustrate, in some embodiments the processor 102 can identify an amount of processing activity at one or more of the processor cores 104 and 105 using a hardware performance monitor, performance monitoring software, and the like, or a combination thereof. For example, a hardware performance monitor could monitor the rate at which instructions are retired at the processor cores 104 and 105. Based on this performance measurement, the cache controller 115 can adjust the size of each of the L2 caches 110 accordingly. For example, if the processor core 104 is using the L2 cache 112, and the rate of instruction retirement indicates a high level of processing activity, the cache controller 115 can increase the number of ways in each set of the L2 cache 112 to increase the number of resources available to the processor core 104. If the rate of instruction retirement indicates a low level of processing activity, the cache controller 115 can reduce the number available ways in each set of the L2 cache 112, thereby conserving power while still providing enough ways for the processor core 104 to operate efficiently.

In some embodiments, each of the processor cores 104 and 105 can enter and exit different power states, whereby a higher power state indicates a higher level of processor activity and a lower power state indicates a lower level of processor activity.

Accordingly, the cache controller 115 can set the size of the L2 caches 110 based on the power states of each of the processor cores 104 and 105. For example, if the processor core 105 is using the L2 cache 112, and the processor core 105 enters a lower power state, indicating a reduced amount of processing activity, the cache controller 115 can decrease the number of ways in each set of the L2 cache 112 to conserve power. If the processor core 105 later returns to a higher power state, in response the cache controller 115 can increase the number of ways at each set of the L2 cache 112 to account for the increased processing activity. The cache controller 115 thereby maintains processing efficiency for the processor core 105 during periods of high activity while conserving power during periods of lower activity when all of the ways of the L2 cache 112 are less likely to be utilized.

When the number of ways at each set of the cache 112 is reduced, such that some ways are removed, the memory hierarchy 145 preserves the data from the removed ways. In some embodiments, the L2 caches 112 and 114 are write-through caches, whereby when data is stored at one these caches the data is, as a matter of course, copied to other levels of the memory hierarchy, such as the memory 150. In such embodiments, the number of ways of the L2 caches 112 and 114 can be decreased without transferring data from the removed ways to the memory 150, because the data has previously been transferred as via the write-through process. In some embodiments, the L2 caches 112 and 114 are write-back caches, whereby data at a cache way is only transferred to another level of the memory hierarchy 145 in response to the data at the way being replaced. In such embodiments, when the number of ways of a cache is reduced, the data at the reduced ways is flushed by copying the data to another level of the memory hierarchy 145, such as to the memory 150. The flush operation may impose a performance penalty at the L2 caches 112 and 114, and this performance penalty can be taken into account as the processor 102 determines whether the size of one of the L2 caches 112 and 114 can be reduced.

In some embodiments, the cache controller 115 adjusts the size of one or more of the L2 caches 110 in response to a context switch at one of the processor cores 104 and 105, wherein the context switch indicates the processor core has switched from executing one thread to executing another thread. For example, after a thread switch the executing thread may be likely to require a high degree of processing activity. Accordingly, the cache controller 115 can increase the size of one or more of the L2 caches 110 in order to account for the expected amount of processing activity.

In some embodiments, the cache controller 115 does not respond to all indications of processor activity changes, but instead periodically polls the processor cores 104 and 105 about their levels of processing activity and makes commensurate adjustments in the sizes of the L2 caches 110. Such periodic adjustment can reduce the likelihood of frequent adjustments in the sizes of the L2 caches 110, thereby improving processing efficiency.

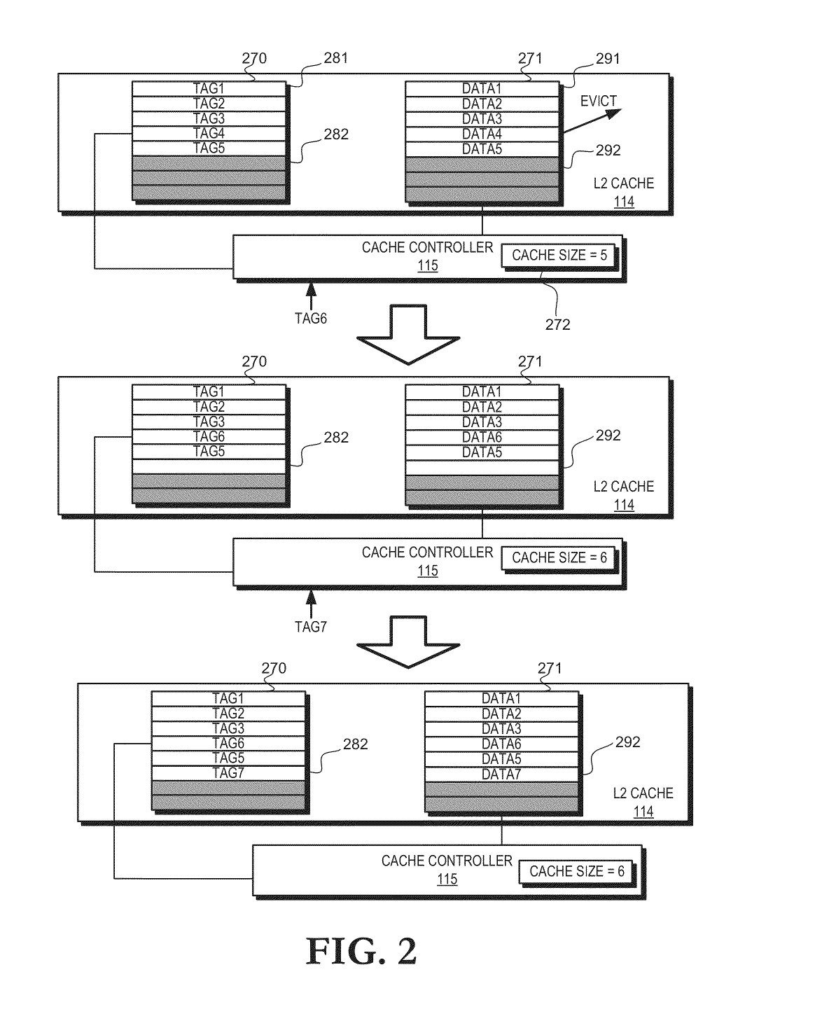

FIG. 2 illustrates an example of the changing of the cache size for the L2 cache 114 by changing the number of ways in each set of the cache in accordance with some embodiments. In the illustrated example, the L2 cache 114 includes a tag array 270 and a set 271. For clarity of illustration, the other sets of the L2 cache 114 are not depicted, but when the L2 cache 114 is increased in size, each set is increased as described below with respect to set 271.

In the illustrated example, the set 271 includes a number of ways, such as ways 291 and 292, whereby each way is a set of bit cells that can store data. The storage and retrieval of data from a way requires the switching and maintenance of the bit cells' transistors to defined states, thereby consuming power. Accordingly, the amount of power consumed by the L2 cache 114 depends in part upon the number of ways used to store data. Accordingly, by limiting the number of ways of the L2 cache 114 that store data, the cache controller 115 reduces the power consumption of the L2 cache 114 at the potential cost of an increased cache eviction rate and commensurate reduced processing efficiency.

The tag array 270 includes a number of entries, such as entries 281 and 282, with each entry able to store a tag indicating the memory address of the data stored at a corresponding way of the sets of the L2 cache 114. For a memory access operation, a processor core supplies to the cache controller 115 a tag indicating the memory address associated with the memory access operation. The cache controller 115 supplies the received tag to the tag array 270, which provides an indication as to whether it stores the supplied tag. If the tag array 270 does store the tag, it indicates a cache hit and in response the cache controller 115 uses the memory address of the memory access operation to access the way that stores the data associated with the memory address.

If the tag array 270 does not store the tag, it indicates a cache miss and the cache controller 115 retrieves the data associated with the memory address from the memory 150. In response to receiving the data, the cache controller 115 determines if there is an available way to store the data and, if so, stores the data at the available way. In addition, the cache controller 115 stores the tag for the memory address of the data at the tag array 270. If there is not an available way, the cache controller 115 selects a way for eviction based on an eviction policy (e.g. an LRU policy) and evicts the data from the selected way by storing the retrieved data at the selected way. In addition, the cache controller 115 replaces the tag for the evicted data with the tag for the retrieved data.

In some embodiments, the cache controller 115 sets the size of the L2 cache 114 by setting the number of entries of the tag array 270 that are used, and the number of ways of the set 271 (and for each other set of the L2 cache 114). To illustrate, in the depicted example the cache controller 115 includes a cache size register 272 that stores a size value indicating the size of the L2 cache 114. The size value governs the number of entries the cache controller 115 uses at the tag array 270 and the number of ways of each set of the L2 cache 114 that are used to store data. In FIG. 2, tag array entries and ways that are available for use are illustrated with a white background and tag array entries and ways that are not available for use are illustrated with a gray background. Accordingly, in the illustrated example the tag array entry 282 and the way 292 are initially unavailable for use.

In the example of FIG. 2, the cache controller 115 initially sets the size of the L2 cache 114 to five, such that there are five entries available at the tag array 270 for set 271, and five corresponding ways of set 271. In response to receiving a sixth tag (designated “TAG6”) associated with a memory access, the cache controller 115 supplies TAG6 to the tag array 270, which indicates a cache miss. In response, the cache controller 115 retrieves the data (designated “DATA6”) associated with the memory address of the memory access. In addition, the cache controller 115 determines that the set 271 stores five valid data entries, which is the maximum allowed as indicated by the cache size register 272. In response, the cache controller 115 selects a way of set 271 for eviction and evicts the data by storing DATA6 at the selected way and storing TAG6 at the corresponding entry of the tag array 270.

In addition, in the example of FIG. 2 the cache controller 115 increases the value at the cache size register 272 to six in response to a defined event at the processing system 100, such as an increase in processing activity. This causes way 292, and the corresponding tag array entry 282, to become available to respectively store data and a corresponding tag. Accordingly, in response to receiving a seventh tag (designated “TAG7”) associated with a memory access the cache controller 115 supplies TAG6 to the tag array 270, which indicates a cache miss. In response, the cache controller 115 retrieves the data (designated “DATA7”) associated with the memory address of the memory access. In addition, the cache controller 115 determines that the set 271 stores five valid data entries, which is less than the maximum number indicated by value stored at the cache size register 272. Accordingly, the cache controller 115 stores DATA7 at the available way 292 and the corresponding tag at entry 282. Thus, way 292 is not used until, for example, processing activity exceeds a threshold, thereby conserving power until activity at the processing cores 104 and 105 is such that processing efficiency is likely to be unduly impacted.

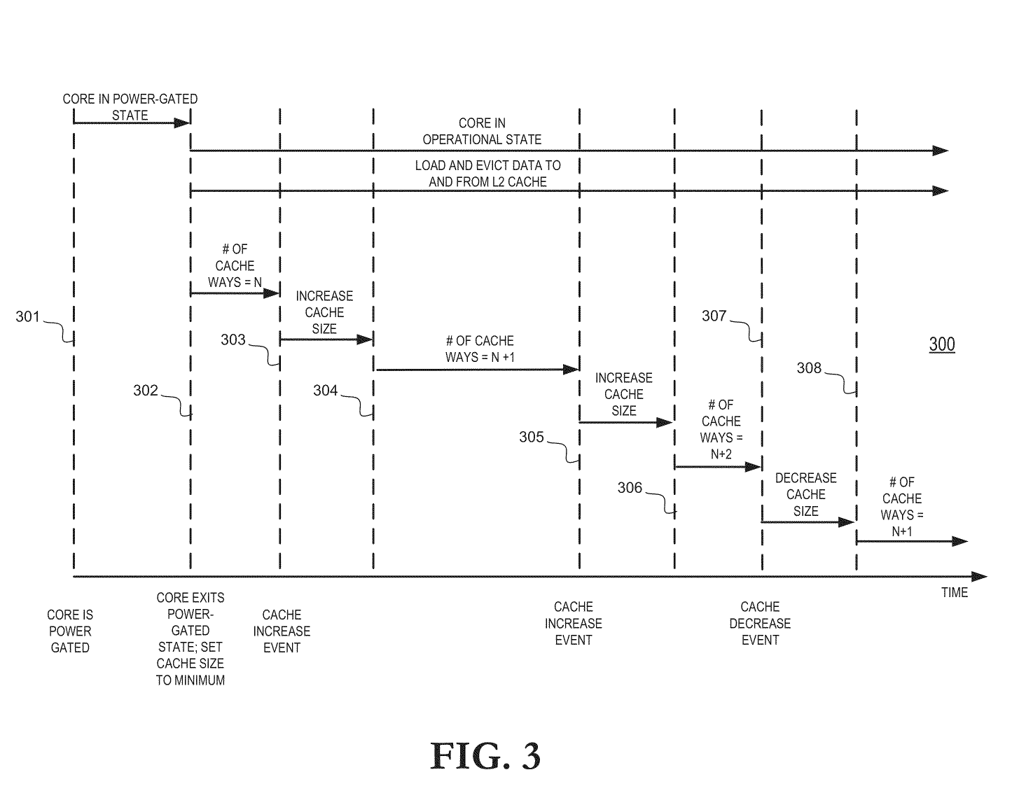

FIG. 3 illustrates a timeline 300 showing an example of the cache controller 115 adjusting the size of an L2 cache in accordance with some embodiments. For purposes of illustration, FIG. 3 is described with respect to adjustment of the size of L2 cache 114. At time 301 the power control module 130 power gates the processor core 105 to place it in a low power state. Accordingly, between time 301 and 302 the L2 cache 114 is not used. At time 302, in response to defined system conditions (e.g. additional program threads being scheduled for execution) the power control module 130 resumes provision of power to the processor core 105, which exits the low-power state. Accordingly, beginning at time 302 the processor core 105 is in an operational state where it executes instructions, and therefore data is stored and retrieved from the L2 cache 114. In addition, in response to the processor core 105 exiting the low-power state, the cache controller 115 sets the size of the L2 cache 114 to a defined minimum size N, where N indicates the number of ways assigned to each set in the cache.

At time 303, the cache controller 115 determines that a cache increase event has occurred, such as a thread switch or an increase in processing activity at the processor core 105 has exceeded a programmable threshold. The cache increase event indicates that the program thread executing at the processor core 105 is experiencing a high level of memory access activity, such that a limited L2 cache size may adversely impact processing efficiency. Accordingly, at time 304 the cache controller 115 increases the size of the L2 cache 114 to N+1, such that each set of the cache includes N+1 ways.

At time 305, the cache controller 115 determines that another cache increase event has occurred. This cache increase event may be similar to or different from the cache increase event at time 302. For example, the cache increase event at time 302 may be an increase in processing activity and the cache increase event at time 305 may be a context switch at the processor core 105. In response to the cache increase event at time 305, at time 306 the cache controller 115 increases the size of the L2 cache 114 to N+2.

At time 307, cache controller 115 identifies a cache decrease event, such as a thread switch or a decrease in processing activity at the processor core 105. Accordingly, at time 308 the cache controller 115 decreases the size of the L2 cache 114 to N+1, such that each set of the cache has N+1 available ways. If the L2 cache 114 is a write-back cache, the cache controller 115 can also copy the data from the reduced ways to higher levels of the memory hierarchy 145. Thus, the cache controller 115 can repeatedly adjust the size of the L2 cache 114 in response to different events at the processor core 105, thereby balancing power conservation and processing efficiency according to conditions at the processor core 105. In some embodiments, the cache controller 115 moves data from the way being disabled to a different way and evicts the data from the other way instead of evicting the data from the way being disabled.

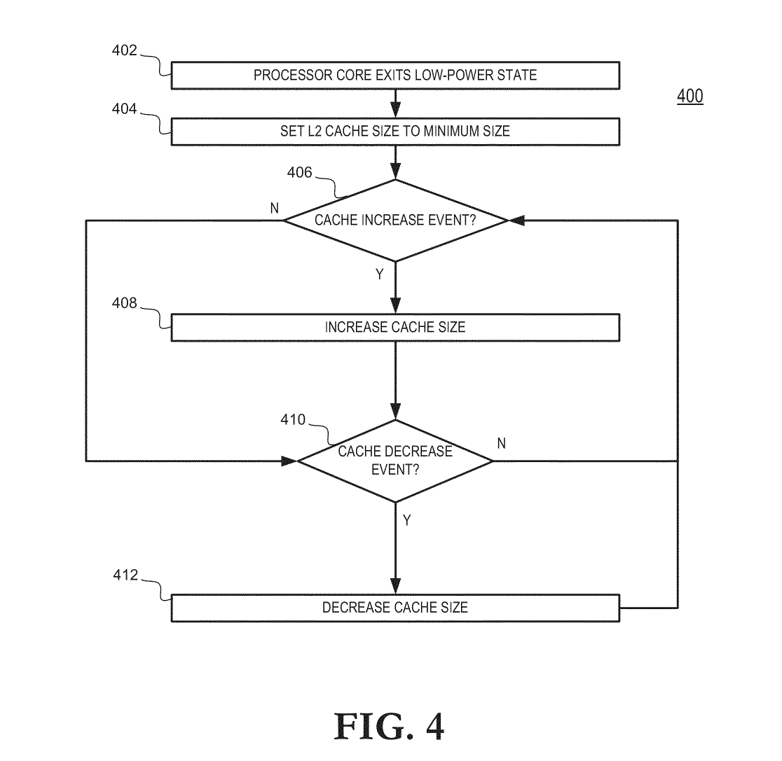

FIG. 4 illustrates a flow diagram of a method 400 of adjusting the size of a cache based on a performance metric in accordance with some embodiments. The method 400 is described with respect to an example implementation at the processing system 100 of FIG. 1. At block 402 the processor core 104 exits a low-power state where it is not performing any processing activity, such as a sleep state. In response, at block 404 the cache controller 115 sets the size of the L2 cache 114 to a minimum size. At block 406 the cache controller 115 identifies whether a cache increase event, such as processing activity at the processor core 104 increasing above a threshold, a context switch at the processor core 104, the processor core 104 moving to another higher-power state, and the like. If the cache controller 115 does not identify a cache increase event, the method flow moves to block 410, described below. If the cache controller 115 does identify a cache increase event, at block 408 it increases the size of the L2 cache 114 by increasing the number of ways at each set of the cache, so that all of the sets have the same increased number of ways. The method flow moves to block 410.

At block 410, the cache controller 115 identifies whether a cache decrease event, such as processing activity at the processor core 104 falling below a threshold, a context switch at the processor core 104, the processor core 104 moving to a lower power state where it still executes instructions, and the like. If the cache controller 115 does not identify a cache decrease event, the method flow returns to block 406. If the cache controller 115 does identify a cache decrease event, at block 412 it decreases the size of the L2 cache 114 by decreasing the number of ways at each set of the cache, so that all of the sets have the same decreased number of ways. If the L2 cache 114 is a write-back cache, it also flushes the reduced ways by copying the data at the reduced ways to a higher level of the memory hierarchy 145. The method flow returns to block 406. The cache controller 115 thereby repeatedly adjusts the size of each set of the L2 cache 114 to balance power consumption and processing efficiency.

In some embodiments, the apparatus and techniques described above are implemented in a system comprising one or more integrated circuit (IC) devices (also referred to as integrated circuit packages or microchips), such as the processor described above with reference to FIGS. 1-4. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

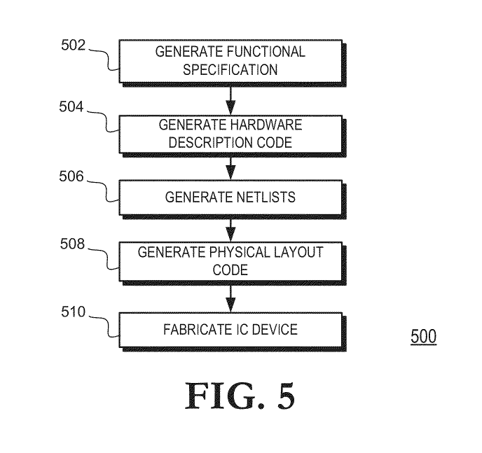

FIG. 5 is a flow diagram illustrating an example method 500 for the design and fabrication of an IC device implementing one or more aspects in accordance with some embodiments. As noted above, the code generated for each of the following processes is stored or otherwise embodied in computer readable storage media for access and use by the corresponding design tool or fabrication tool.

At block 502 a functional specification for the IC device is generated. The functional specification (often referred to as a micro architecture specification (MAS)) may be represented by any of a variety of programming languages or modeling languages, including C, C++, SystemC, Simulink, or MATLAB.

At block 504, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 506 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 508, one or more EDA tools use the netlists produced at block 506 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 510, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored on a computer readable medium that, when executed by the one or more processors, manipulate the one or more processors to perform one or more aspects of the techniques described above. The software is stored or otherwise tangibly embodied on a computer readable storage medium accessible to the processing system, and can include the instructions and certain data utilized during the execution of the instructions to perform the corresponding aspects.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method, comprising:
during operation of a processor, adjusting a size of a set-associative cache of the processor by changing a number of ways of each set of the cache available to store data.

2. The method of claim 1, wherein adjusting the size of the cache comprises:
setting the size of the cache to a first size in response to a processor core of the processor exiting a low-power state; and
adjusting the size of the cache from the first size to a second size in response to a first level of processing activity at the processor.

3. The method of claim 2, wherein the second size is greater than the first size.

4. The method of claim 2, wherein the second size is smaller than the first size.

5. The method of claim 2, wherein adjusting the size of the cache further comprises:
adjusting the size of the cache from the second size to a third size in response to a second level of processing activity at the processor.

6. The method of claim 5, wherein the second size is greater than the first size and the third size is smaller than the second size.

7. The method of claim 5, wherein the second size is smaller than the first size and the third size is greater than the first size.

8. The method of claim 1, wherein adjusting the size of the cache comprises adjusting the size of the cache in response to a context switch at the processor indicating a processor core of the processor has switched from executing a first thread to executing a second thread.

9. The method of claim 1, wherein adjusting the size of the cache comprises adjusting the size of the cache in response to the processor exiting a low-power state.

10. The method of claim 1, wherein the cache is shared between a first processor core and a second processor core of the processor.

11. A method, comprising:
dynamically changing a size of a set-associative cache of a processor by dynamically changing a number of ways of each set of the cache available to store data.

12. The method of claim 11, wherein changing the size of the set-associative cache comprises periodically adjusting the size of the set-associative cache based on a power state of the processor.

13. The method of claim 11, wherein periodically adjusting the size of the cache comprises periodically adjusting the size of the cache based on an amount of processing activity at the processor.

14. A processor, comprising:
a processor core;
a cache; and
a cache controller to adjust a size the by changing a number of ways of each set of the cache available to store data.

15. The processor of claim 14, wherein the cache controller is to adjust the size of the cache by:
setting the size of the cache to a first size in response to the processor core exiting a low-power state; and
adjusting the size of the cache from the first size to a second size in response to a first level of processing activity at the processor core.

16. The processor of claim 15, wherein the second size is smaller than the first size.

17. The processor of claim 15, wherein the second size is larger than the first size.

18. The processor of claim 15, wherein the cache controller is to further adjust the size of the cache by:
adjusting the size of the cache from the second size to a third size in response to a second level of processing activity at the processor core.

19. The processor of claim 18, wherein the second size is greater than the first size and the third size is less than the second size.

20. The processor of claim 18, where the second size is less than the first size and the third size is greater than the first size.
